(19) United States
(12) Patent Application Publication
(10) Pub. No.: US 2024/0238737 A1
(43) Pub. Date: Jul. 18, 2024

(54) PEEK MEMBRANES AND RELATED METHODS AND DEVICES

(71) Applicant: ENTEGRIS, INC., Billerica, MA (US)

(72) Inventors: David Lukas Grzenia, North Billerica, MA (US); Vinay Kalyani, Salem, NH (US); Puth Proeung, Lowell, MA (US); William Joseph Lorenzi, Nashua, NH (US); Tanya Srivastava, Lowell, MA (US)

(21) Appl. No.: 18/416,626

(22) Filed: Jan. 18, 2024

Related U.S. Application Data
(60) Provisional application No. 63/439,814, filed on Jan. 18, 2023.

(51) Int. Cl. B01D 71/52; B01D 67/00; B01D 69/02; B01D 69/06

(52) U.S. Cl. CPC B01D 71/5222; B01D 67/0011; B01D 67/0013; B01D 67/0016; B01D 67/003; B01D 69/02; B01D 69/06; B01D 2323/12; B01D 2323/219; B01D 2325/02; B01D 2325/04; B01D 2325/34

(57) ABSTRACT

Described are porous polymeric filter membranes made using poly(etheretherketone)-type polymers (PEEK), devices that include the PEEK membrane, and related methods of preparing and using the PEEK membranes.

### FIELD

The present description relates to porous polymeric filter membranes made using poly(etheretherketone)-type polymers (PEEK), devices that include the PEEK membrane, and related methods of preparing and using the PEEK membranes.

### BACKGROUND

Filter membranes and filter products are indispensable tools of modern industry used for removing unwanted materials (contaminants, particulates, impurities, and the like) from a flow of a useful fluid. Useful fluids that are processed using filters include water, liquid industrial solvents and processing fluids, industrial gases used for manufacturing, and liquids that have medical or pharmaceutical uses, among many others. Unwanted materials that are removed from a fluid may be an impurity or contaminant in the form of a solid particle, a microorganism, volatile organic materials, and chemical species contained in a gaseous or liquid fluid. Commonly, the fluid that is being processed or processing conditions can challenge the stability of a filter product, e.g., the fluid may be one that chemically degrades a material of a filter, or processing conditions may involve high temperature, or both.

Features of a filter membrane such as chemical composition, size, dimensions, and physical properties (e.g., porosity, pore size) relate to measured performance properties (e.g., “bubble point,” “flow time,” retention, and the like). Within present limits of the ranges of these features, a filter may include size (e.g., thickness), porosity, and pore size features that have a useful balance for filtering performance (retention) when used with a specific type of fluid and at a specific flow rate (flow time). Typical pore sizes are in the micron or sub-micron range, such as from about 0.001 micron to about 10 micron. Membranes with average pore size of from about 0.001 to about 0.05 micron are sometimes classified as ultrafilter membranes. Membranes with pore sizes between about 0.05 and 10 microns are sometimes classified as microporous membranes.

For commercial use, a filter membrane must be capable of performing as a filter in a manner that is efficient and reliable, e.g., must be capable of efficiently removing a high amount of impurities from a continuous flow of fluid that passes through the filter membrane. Filtering performance can be assessed, for example, by flow time (FT) and retention. Flow time is a measure of the rate of fluid that flows through a filter membrane and must be sufficient to allow for a filter membrane to be used commercially. Retention refers to the amount (in percent) of impurities removed from a flow of fluid through a filter membrane. Porosity, pore size, and bubble point can affect both flow time and retention. A membrane with smaller pores, which can be desirable to improve retention, can have a higher bubble point and a longer (but still useful) flow time. A larger pore size may correlate to relatively lower retention but shorter flow time and a lower bubble point. For commercial use, a filter membrane must provide a good combination of flow time and filtering performance (e.g., as measured by retention).

Poly(oxy-1,4-phenylencoxy-1,4-phenylene-carbonyl-1,4-phenylene), more commonly known as poly(etheretherketone), or PEEK, has advantageous physical properties and chemical and thermal stability for many uses, including as filter membranes. A high melting point, high glass transition temperature, low solubility, and good chemical resistance make PEEK a material known for use in filtration applications in challenging environments. PEEK is stable at high temperatures (e.g., 300 degrees Celsius), and in the presence of common organic solvents at room temperature. PEEK is also relatively stable in hydrogen peroxide, acids, and bases, with the exception of strong acids in high concentrations.

Presently-known techniques for manufacturing PEEK filter membranes are limited with respect to the degree to which flow and retention properties can be increased and balanced. Processing of PEEK into a membrane structure using a non-solvent induced phase separation (NIPS) process is challenging because of its high degree of stability in organic and inorganic solvents. Processing PEEK using a thermal induced phase separation has been attempted (see U.S. Pat. No. 4,957,817), but the porous structures that are form can lack a highly desirable combination of flux, pore size, and morphology.

### SUMMARY

This description relates to porous membranes that are made with poly(etherether ketone), filtering devices that contain the membranes, and methods of using the membranes and the devices to remove a contaminant from a liquid or a gaseous fluid.

The description also relates to methods of preparing a porous PEEK membrane by forming a heated polymer-containing liquid (e.g., a “casting solution”) that contains PEEK in a non-solid form in an organic liquid, referred to as a “solvent.” The solvent is non-polar and has a boiling point that is higher than a melting point of the PEEK polymer. The PEEK polymer that is contained in the heated solvent is in a non-solid form, e.g., melted or dissolved, and the heated casting solution is a homogeneous liquid solution.

In example methods, the membrane is formed according to a melt-cast process, for example a method of the type referred to as “thermally-induced phase separation” methods (“TIPS”). In these example methods, the PEEK polymer is preferably a non-sulfonated form of PEEK polymer and the non-polar solvent of the casting solution is triphenyl methane.

Also according to example processes, a porous PEEK polymer membrane can be prepared to exhibit a desirable or advantageous balance of physical and performance properties. By example methods, PEEK polymer material that will form the porous membrane is dissolved at an elevated temperature in non-polar solvent that is in a liquid form when heated and has a high boiling point. The polymer dissolved in the solvent forms a heated homogeneous casting solution that contains the polymer fully dissolved or melted in the solvent. The casting solution is then shaped, e.g., by casting the heated casting solution onto a flat and smooth surface to form a thin film of the heated casting solution on the surface, or by another shaping technique such as by extrusion or to form a tubular membrane. The casting solution, after being shaped, is then cooled to induce a phase change of the PEEK polymer within the solution. The polymer forms a solidified, shaped polymer body (e.g., a porous flat film or a porous tubular body) that includes the solidified polymer material with small pores formed therein. The pores contain a portion of the original solvent, which is subsequently removed to leave the porous membrane.

Example porous PEEK membranes can exhibit a desirable combination of flow and pore size (measured by bubble point), preferably a combination of high flow and high bubble point that is improved compared to porous PEEK membranes made by different methods.

Examples porous filter membranes can have an initial bubble point of at least 25, 30, or 40 pounds per square inch (psi) or greater, a mean bubble point of at least 25, 30, or 40 pounds per square inch (psi) or greater (measured using HFE-7200 (3M), at a temperature of 22 degrees Celsius), or both. A preferred membrane can also have a useful or a relatively low (compared to other porous PEEK membranes) flow time in combination with a bubble point as described, e.g., a measured flow time that is below about 5,000 seconds or under 4,000 seconds measured using IPA, and a measured flow time that is below about 5,000 seconds, 4,000 seconds, or under 3,000 seconds measured using water. The membrane also exhibits useful filtering properties as measured by retention.

In one aspect, the invention relates to a porous polyether ether ketone membrane having: a flow time of less than 10,000 seconds measured using isopropyl alcohol (500 milliliters) with a membrane surface area of 13.5 cm², and a pressure of 14.5 psia; and an initial bubble point of at least 25 pounds per square inch (psig), measured using HFE-7200 at a temperature of 21 degrees Celsius.

In another aspect, the invention relates to a method of preparing a porous polyether ether ketone membrane. The method comprises preparing a combination comprising: from 20 to 40 weight percent polymer that comprises polyether ether ketone, and from 60 to 80 weight percent solvent that has a boiling point that is higher than a melting point of the polymer, based on total weight of the combination; heating the combination to form a homogeneous casting solution; causing polyetherether ketone of the casting solution to coagulate to form a porous membrane; and removing solvent from the porous membrane.

In yet another aspect, the invention relates to a homogeneous polymer-containing liquid that contains polyether ether ketone polymer melted in solvent. The liquid contains: from 20 to 40 weight percent polymer that comprises polyetherether ketone; and from 60 to 80 weight percent solvent that has a boiling point that is higher than a melting point of the polyether ether ketone, based on total weight polymer-containing liquid.

### BRIEF SUMMARY OF THE DRAWINGS

FIG. 1 is a schematic view of a method and system useful according to the present description.

FIGS. 2A through 2T are images of porous PEEK membranes as described, and images of comparative PEEK membranes prepared with polar solvents.

FIG. 3 shows retention data for a filter as described and a comparative filter.

FIG. 4 shows test data relating to a degree of sulfonation of a sample PEEK polymer.

FIG. 5 is an SEM image of a membrane as described.

### DETAILED DESCRIPTION

The following description relates to methods of making porous filter membranes from poly(etherether ketone) (PEEK). Example methods include those sometimes referred to as melt-cast processes, for example methods referred to as “thermally-induced phase separation” methods (“TIPS”) further performed based on details described herein with respect to the use of non-polar solvent that has a high boiling point (e.g., triphenyl methane) to dissolve the PEEK polymer.

According to example processes, porous membranes made using PEEK polymer can be prepared to exhibit a desirable or advantageous balance of physical and performance properties. By example methods, PEEK polymer material that will form the porous membrane is dissolved at an elevated temperature in non-polar solvent that is in a liquid form when heated and has a high boiling point. The polymer dissolved in the solvent forms a heated homogeneous casting solution that contains the polymer fully dissolved or melted in the solvent. The casting solution is then shaped, e.g., by casting the heated casting solution onto a flat and smooth surface to form a thin film of the heated casting solution on the surface, or by another shaping technique such as by extrusion or to form a tubular membrane. The casting solution, after being shaped, is then cooled to induce a phase change of the PEEK polymer within the solution. The polymer forms a solidified, shaped polymer body (e.g., a porous flat film or a porous tubular body) that includes the solidified polymer material in the form of a solid polymeric scaffold or matrix having a network of connected pores formed therein. At the time of the polymer being solidified by cooling, the original solvent of the casting solution remains present within the pores and can be subsequently removed to leave the porous membrane.

The solvent of the casting solution includes (e.g., comprises, consists of, or consists essentially of) non-polar solvent that has a high boiling point. A high boiling point is a boiling point that is at least higher than the melting point of the PEEK polymer, for example a boiling point of at least 340 degrees Celsius, or at least 350 degrees Celsius. One example of a non-polar solvent that has a high boiling point as described is triphenyl methane, which has a boiling point of 359 degrees Celsius. Optionally, the solvent may be a single type of solvent or may be a combination of two or more different chemical solvent materials, at least one of which is a non-polar high boiling point solvent. In example casting solutions, a total amount of solvent in a casting solution is mostly or entirely a non-polar solvent that has a high boiling point as described, e.g., the total amount of solvent in the casting solution is made from (comprises, consists of, or consists essentially of) at least 75, 90, 95, or 99 weight percent non-polar solvent that has a high boiling point, such as triphenyl methane.

Past descriptions have used polar organic solvents to prepare solutions of PEEK for casting and forming polymeric membranes. See U.S. Pat. No. 4,957,817. Solvents described in the '817 patent include benzophenone (boiling point 379 degrees Celsius), diphenylsulfone (boiling point 305 degrees Celsius), dimethylphthalate (boiling point 284 degrees Celsius), among others. The membranes that are produced by those processes have physical and performance properties that on balance can be improved.

A PEEK membrane as described can be formed by dissolving PEEK in solvent as described, at an elevated temperature. The PEEK that is dissolved into the solvent can begin at room temperature as a solid particulate form of PEEK polymer, such as in the form of a powder, pellets, or other convenient or available physical form of PEEK polymer. Various PEEK polymer products are available from commercial sources, including PEEK polymer products that are sold under the registered trademark VICTREX®, and VESTAKEEP® (from Evonik). Based on various factors such as molecular weight of the PEEK polymer, a PEEK polymer may exhibit a range of physical properties, such as melting point. Example PEEK polymers that are commercially available have melting points that are above 300 degrees Celsius, e.g., melting points of at least 320 or 340 degrees Celsius. Victrex PEEK PF has a melting point of 343 degrees Celsius.

A PEEK polymer used to form a membrane can have a molecular weight that allows the polymer to be processed as described herein to produce a mechanically stable porous membrane that is effective as a filter membrane, with flow and bubble points useful for that purpose. Molecular weights of PEEK polymers can be determined by known methods, such as by gel permeation chromatography (GPC) and size exclusion chromatography (SEC). Examples of PEEK polymers that can be useful to form a membrane of the present description may have molecular weights in a range above 70 or 75 Mw, and up to or above 100 or 125 Mw. See Table 5.

PEEK polymer is also available in derivatized forms, including as a sulfonated form, meaning that the polymer is chemically modified to include attached sulfonate (—SO₃H) groups. According to useful and preferred examples of the described PEEK polymers, the PEEK polymer may be non-derivatized, especially non-sulfonated, i.e., does not contain a significant amount of sulfonate groups. In certain examples, useful PEEK polymer may have a degree of sulfonation that is less than 3 percent, e.g., less than 2 percent, or less than 1 percent.

The casting solution can contain a total amount of polymer that is mostly or entirely PEEK polymer, e.g., may be made from (comprise, consist of, or consist essentially of) at least 75, 90, 95, or 99 weight percent non-sulfonated PEEK polymer based on total polymer in the casting solution. Optionally, if desired, the casting solution may contain another type of polymer combined with the PEEK polymer, but useful casting solutions and porous membranes as described may contain mostly or entirely PEEK polymer, e.g., non-sulfonated PEEK polymer. The PEEK polymer may be of a single type, e.g., one PEEK polymer ingredient having a single defined molecular weight and melting point, or may be a blend of different types of PEEK polymer having different molecular weights and different melting points.

The amounts of polymer and solvent in a casting solution can be relative amounts that allow the heated casting solution to be shaped and then further processed to form a porous PEEK membrane as described, e.g., by casting or extruding followed by cooling to cause coagulation of the PEEK polymer to form a porous shaped body (porous polymer body), and then processed to remove solvent of the casting solution from the porous polymer body. An example casting solution may contain from 10 to 40 weight percent PEEK polymer and from 60 to 90 weight percent solvent based on total weight casting solution or based on total weight PEEK polymer and solvent; e.g., from 15 to 35 weight percent PEEK polymer and from 65 to 85 weight percent solvent based on total weight casting solution or based on total weight PEEK polymer and solvent; or from 20 to 30 weight percent polymer and from 70 to 80 weight percent solvent based on total weight casting solution or based on total weight PEEK polymer and solvent. The casting solution contains mostly or entirely the polymer and the solvent, e.g., at least 80, 90, 95, or 99 weight percent polymer and solvent based on total weight casting solution.

A useful process, in more detail, can be based on a thermally-induced phase separation process that includes phase separation of the polymer from the solvent, induced by a reduction of temperature of the heated casting solution after shaping. According to such methods, the heated casting solution that contains polymer dissolved in solvent is in the form of a homogeneous polymer solution while at the elevated temperature, during shaping. This casting solution is characterized as having a range of temperatures at which the casting solution maintains a state of a homogeneous solution of the polymer dissolved in the solvent, and a second (lower) range of temperatures at which the casting solution will become phase separated, with the PEEK polymer becoming a continuous, coagulated porous polymer body within the solvent.

A useful or preferred temperature of the heated casting solution when prepared for a shaping step can be a temperature that is greater than the melting point of the PEEK polymer, which can vary based on features of the PEEK polymer such as molecular weight. Examples of useful temperatures of a casting solution can be at least 300 degrees Celsius, 320 degrees Celsius, 340 degrees Celsius, or 360 degrees Celsius. During heating, the PEEK will completely dissolve (e.g., melt) within the solvent.

The heated casting solution can be shaped to a desired form such as a thin sheet or a hollow tube, by any useful method such as casting, extrusion, etc., and temperature reduction. By an example method, the heated casting solution is formed into a thin, uniform film on a smooth flat surface (a “casting surface”). The casting surface is maintained at a temperature that is lower than the temperature of the heated casting solution, and the contact between the heated casting solution and the casting surface causes the temperature of the heated casting solution to be reduced. By reducing the temperature of the heated casting solution from the elevated temperature (“casting solution temperature”) to a reduced temperature (referred to as a “cooling temperature” or “shaping temperature”), the heated casting solution separates into two phases: a continuous solid polymer phase in the form of a porous three-dimensional membrane structure (porous polymer body), within a continuous solvent phase.

The temperature of a casting surface (the “cooling temperature” or “shaping temperature”) is a temperature that is below the melting temperature of the PEEK polymer of the casting solution, and below a temperature of the heated casting solution, e.g., a temperature in a range from 20 to 280 degrees Celsius, or from 40 to 250 degrees Celsius, or from 80 to 220 degrees Celsius.

After the temperature of the heated casting solution is reduced and the dissolved polymer is coagulated to form the solid polymer phase (porous polymer body) having a shaped porous membrane structure, the solvent from the casting solution can be removed from the pores of the shaped porous membrane structure, e.g., by application of a different type of solvent (a “washing solvent”) to the membrane structure. The solvent of the casting solution may be removed from the porous polymer body by washing the porous polymer body with a washing solvent that is effective to remove the casting solution solvent. Optionally, two or more different solvents may be used separately, with multiple washing steps. Examples of useful washing solvents include and non-polar solvents, with specific examples including ethyl acetate, dioctyl phthalate, and hydrofluoroethers (HFEs). The step of washing the porous polymer body to remove the casting solution solvent can be performed at any useful temperature, such as a temperature in a range from room temperature (22 degrees Celsius) to 100 degrees Celsius, e.g., from 40 to 80 degrees Celsius.

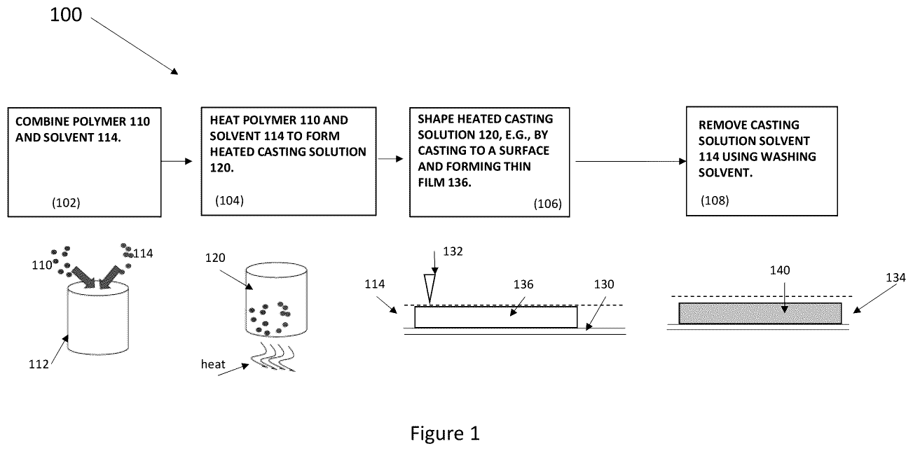

Referring to FIG. 1, illustrated is an example of system and an example series of processing steps for carrying out a method as described. Method 100 includes steps that include: combining (102) solvent and polymer with mixing; heating (104) the mixture of solvent and polymer to form a heated casting solution (120) that contains (comprises, consists of, or consists essentially of) the solvent and the polymer; casting or otherwise shaping (106) the heated casting solution (120), e.g., to form a cast film (136) of the heated casting solution, and then causing polymer in the cast film (136) to coagulate out of solution with the solvent and to become a solid polymer phase in the form of a shaped porous polymer body 140 within the solvent; and then washing (108) solvent from the shaped porous polymer body 140. FIG. 1 shows non-limiting examples of useful steps of a method as described; in other variations the steps of a useful method may be performed differently to convert PEEK polymer dissolved in a heated casting solution 120 into a porous polymer body 140 by a step of shaping the heated casting solution, causing coagulation of polymer in the heated casting solution (e.g., by cooling), followed removing the solvent from the porous polymer body 140.

Referring still to method 100 of FIG. 1, polymer 110 containing (comprising, consisting essentially of, or consisting of) non-sulfonated PEEK polymer is introduced (102) into mixing vessel 112 along with solvent 114, which is non-polar and has a high boiling point as described. Solvent 114 and polymer 110 are mixed and heated (104) to form a heated casting solution (120) that includes the polymer in a melted form dissolved within the solvent. To form the heated casting solution (120), the combined polymer and solvent are heated to a temperature at which the solvent is in liquid form and the polymer melts or dissolves within the solvent to form a homogeneous heated casting solution (120).

The heated casting solution is then shaped (106) into a desired form, which may be a form that is useful as a filter membrane, e.g., a sheet or a tube. The shaping step 106 may be performed by any useful method, using useful equipment, such as extrusion or casting equipment and techniques. As illustrated, shaping step 106 is performed by applying heated casting solution 120 onto flat surface 130 (“casting surface”), optionally with a step of leveling casting solution using a “knife,” “blade,” or other leveling device 132 passed over an upper surface of heated casting solution 120 to form a thin uniform film 136 of heated casting solution 120, still in the presence of casting solution solvent 114.

When the heated casting solution is applied to a casting surface, the heated casting solution is applied while having a temperature that is higher than a melting temperature of the PEEK polymer, e.g., at least 300 degrees Celsius, 320 degrees Celsius, or 340 degrees Celsius. Also when the heated casting solution is applied to the casting surface, the temperature of the casting surface is below the melting temperature of PEEK, below the temperature of the heated casting solution, and is a temperature that causes polymer of the heated casting solution to coagulate (e.g., solidify) or precipitate out of solution to form a separate continuous polymer phase contained in the solvent in a form of a coagulated solid porous polymer body 140 having a porous structure as described herein.

Examples of useful temperatures of a casting surface (e.g., 130) can be temperatures that are between room temperature and the temperature of heated casting solution 120 when applied to the casting surface, e.g., a useful or preferred temperature of a casting surface may be in a range from 20 to 280 degrees Celsius, or from 40 to 250 degrees Celsius, or from 80 to 220 degrees Celsius. The temperature of the casting surface and the rate of cooling of the heated casting solution by contact with the casting surface can affect the physical features and morphology of the porous membrane that is formed, including porosity, pore size, and bubble point of the formed porous membrane, which then individually and together affect the filtering performance of the porous membrane as measured by flow time, retention, and the like.

During the step of cooling the heated casting solution 120 to form porous body 140, solvent of the casting solution remains present within pores of the formed porous body 140. In a subsequent washing step (108) a washing solvent 134 can be used to wash casting solution solvent 114 from porous body 140.

A porous PEEK membrane prepared by a method as described can be effective for use as a filter membrane by allowing a useful fluid to pass through the membrane, in a useful amount and at a useful flow rate, while effectively removing unwanted contaminants or impurities from the fluid to produce a purified filtrate. The membrane is polymeric, porous, and has mechanical properties (e.g., is sufficiently rigid yet flexible) that allow for the membrane to be assembled into and used in the form of a filter product. The membrane has features such as porosity, pore size, thickness, and composition (i.e., polymeric makeup), that together contribute to the properties of the membrane, including performance properties (retention, flow time, among others). The membrane should be sufficiently porous, and with suitable pore size, to allow for liquid fluid to pass through the membrane at a flow rate that is sufficient for the membrane to be used in a commercial filtering application, while removing a high amount (e.g., percentage) of unwanted contaminants or impurities from the liquid.

The filter membrane is porous, and has an “open pore” structure through a thickness of the membrane and at two opposed surfaces, to allow for a desired flow of fluid (e.g., liquid) from one surface of the filter membrane, through the thickness of the filter membrane, to the other surface of the filter membrane. Between the two opposed surfaces, along the thickness of the membrane, are cellular, three-dimensional, void microstructures in the form of enclosed cells, i.e., “open cells” or “pores” that allow for fluid to pass through the thickness of the membrane. The open pores can be referred to as openings, pores, channels, or passageways, which are largely interconnected between adjacent pores to allow fluid to flow through the pores, between the pores, and through the thickness of the membrane.

In example membranes, pores are distributed throughout the thickness of the membrane and arranged in a manner based on position, shape, and size, that may be considered asymmetric, slightly asymmetric, substantially symmetric, isotropic, homogeneous, etc. A membrane that has pores of substantially uniform sizes uniformly distributed throughout the membrane is often referred to as isotropic, or “homogeneous.” An anisotropic (a.k.a., “asymmetric”) membrane may be considered to have a morphology in which a pore size gradient exists across the membrane; for example, the membrane may have a structure with significantly larger pores at one membrane surface, and significantly smaller pores at the other membrane surface. The term “asymmetric” is often used interchangeably with the term “anisotropic.” A membrane as described may be symmetric or asymmetric. A relatively higher cooling temperature of a casting surface may produce a more asymmetric morphology, and a relatively lower cooling temperature may produce a relatively more symmetric morphology of a membrane.

Certain example membranes of the present description may have a porous surface (air side) and a more closed surface (casting side), creating a slightly asymmetric structure. The majority of the membrane remains significantly symmetric and uniform. The membrane may include a high degree of tortuosity as indicated by a smallest pore size measurement, and matrix wall structures that include elongate fibrous or fibrillated walls as compared to more spherical or rounded fused particles, as well as a comparatively high porosity. The matrix walls form high tortuosity pores defined by a matrix of elongate connected strands (fibrils). This type of “fibrillated” matrix differs from matrix walls that are formed from particles that remain in a substantially “fused particle” form, with the matrix being defined by walls that exhibit significantly rounded particle-shaped structures based on particles being fused at adjacent surfaces. The fused particle matrix may also have a lower porosity compared to a fibrillated matrix. Sec table 4.

Example membranes that include fibrillated matrix walls defined by elongate strands may be characterized by factors that include a porosity of at least 70 percent, e.g., porosity in a range from 70 to 85 percent, a smallest pore size in a range below 200 nm, and a largest pore size in a range below 800, 600, 200, or 100 nm.

Pore features of porous membranes can be measured by liquid-liquid porosimetry (or “porosimetrie”) techniques and equipment. These include pore structure, mean pore diameter, largest pore diameter, smallest pore diameter, pore area, and shape, e.g., “tortuosity.”

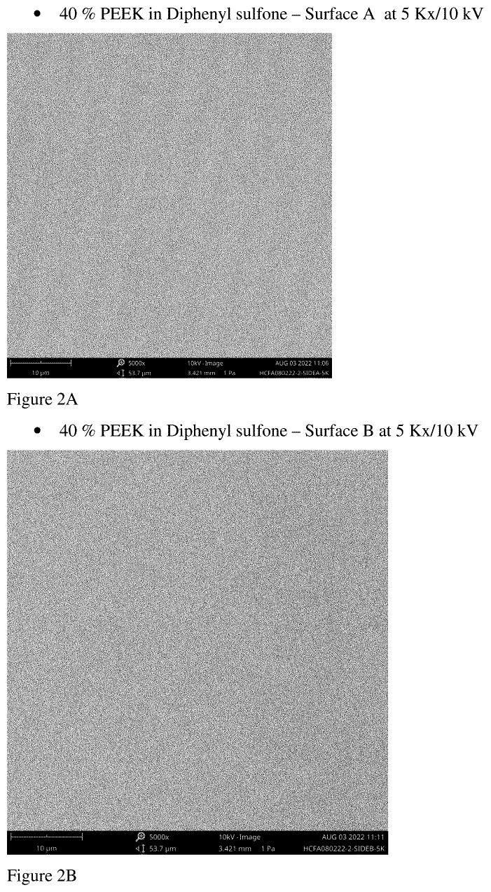

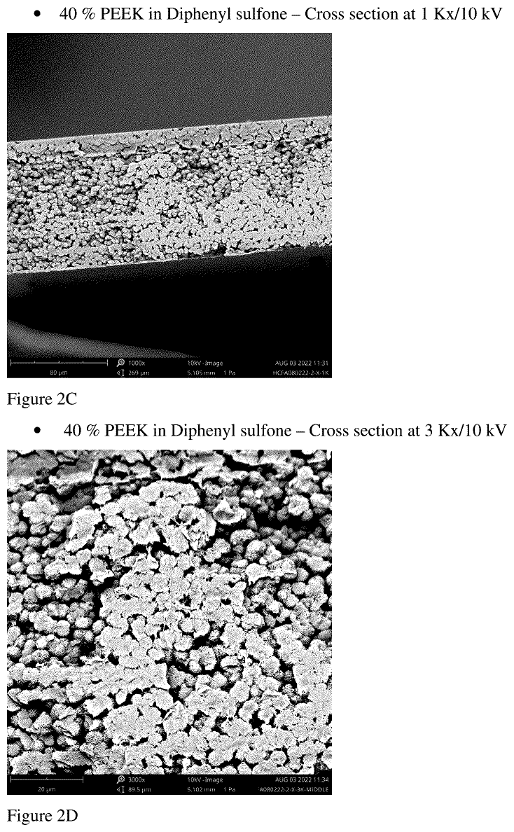

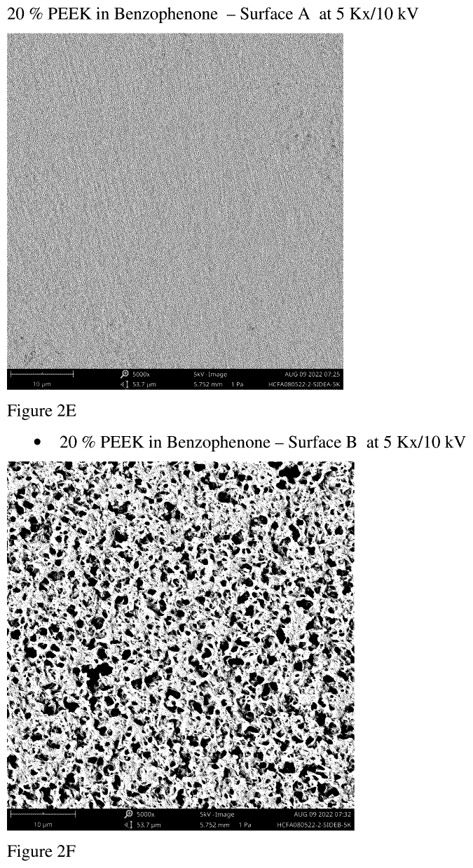

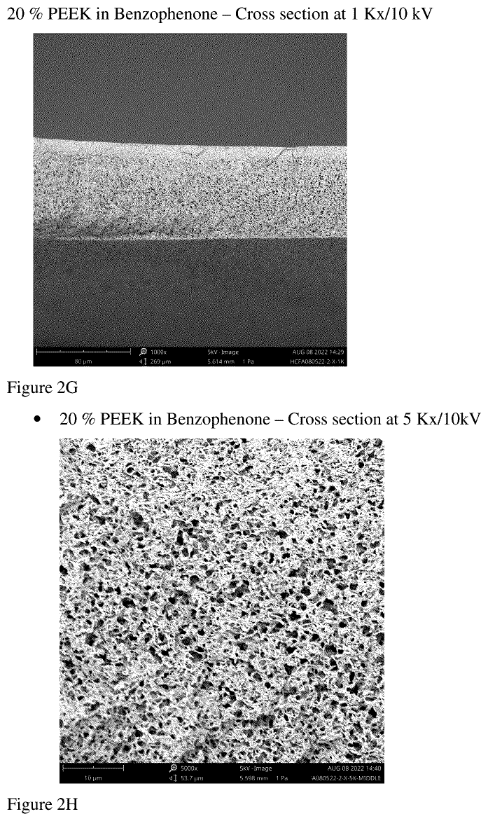

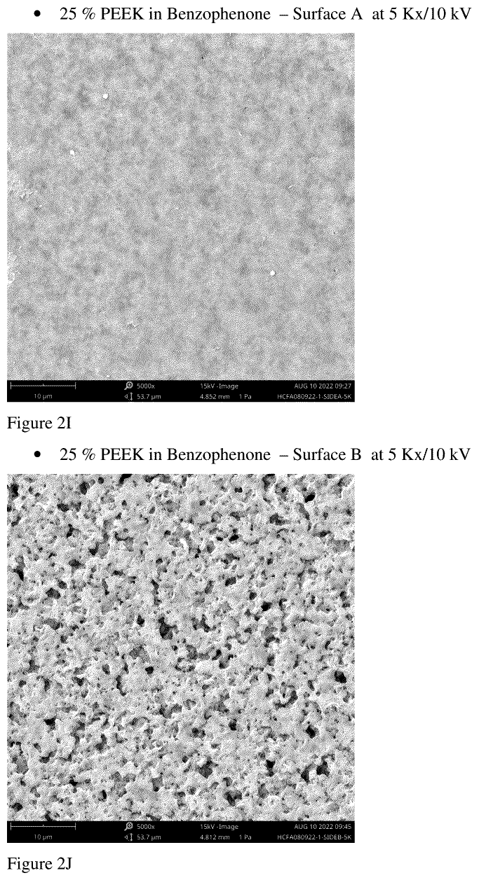

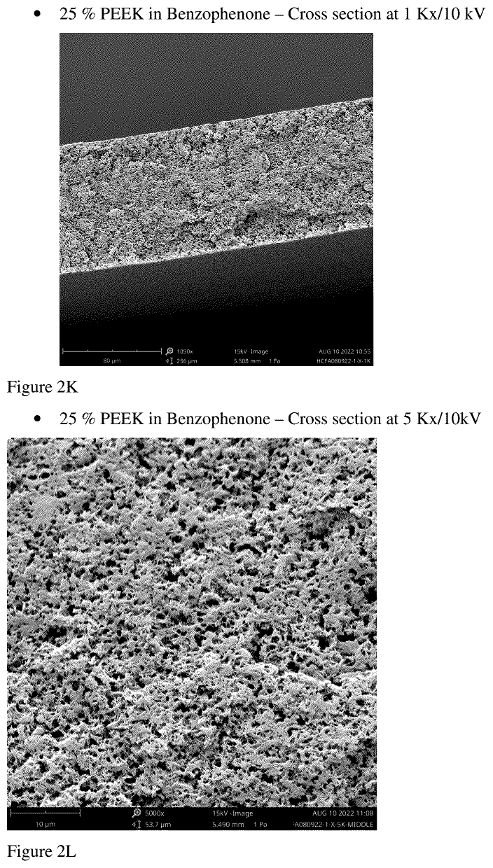

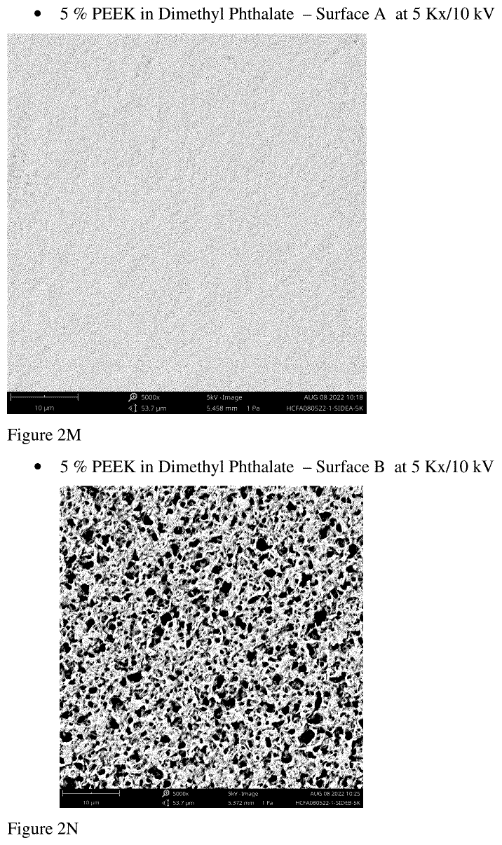

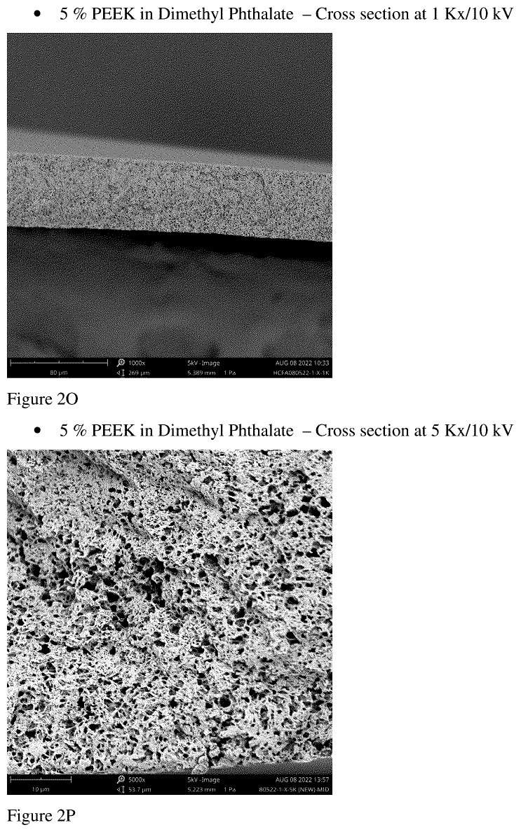

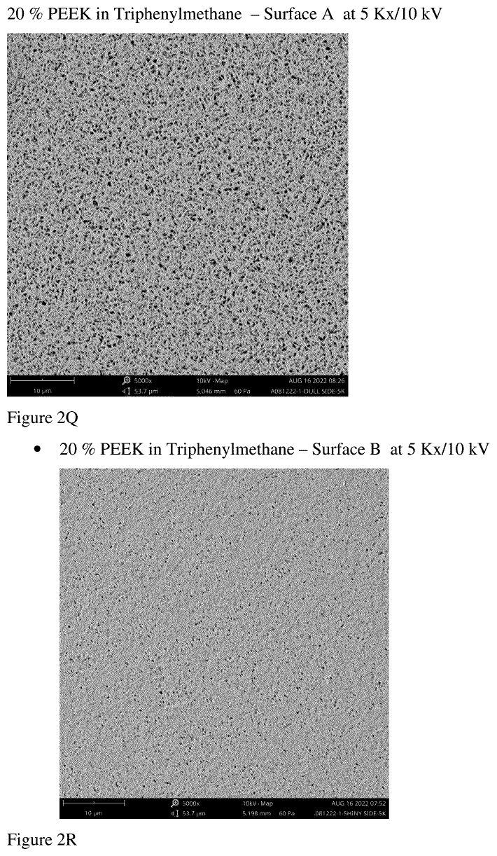

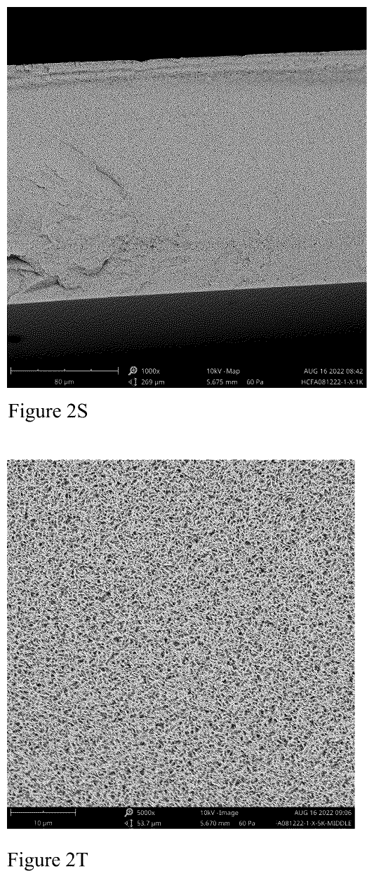

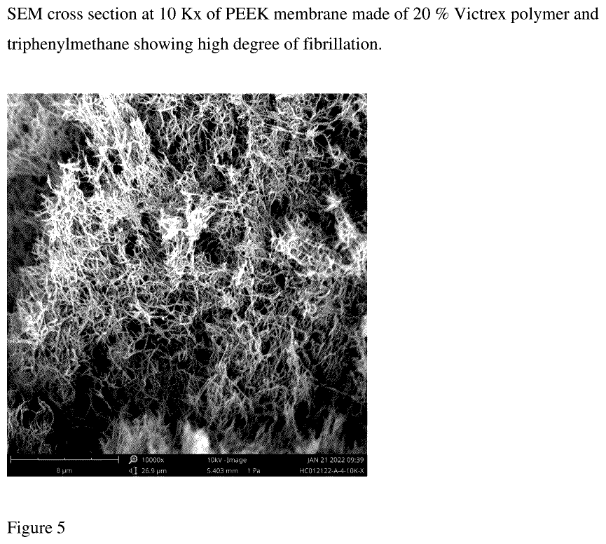

In particular examples, membranes prepared with triphenyl methane as a solvent can have a comparatively high porosity, e.g., in the 80 percent range (such as from 70 to 85 percent), with a smallest pore size in a range from 30 to 100 nm, indicating a high degree of tortuosity. The internal membrane structure of membranes prepared using triphenyl methane can be highly fibrillated with fibers having thin walls, as seen in FIG. 5. This fibrillation is different from the PEEK membranes made using diphenyl sulfone or benzophenone and shown in the SEM images (FIG. 2C, FIG. 2G), which also have lower porosities of 66 percent and 67 percent.

A membrane as described in the form of a thin film can have a thickness dimension that will allow the membrane to be effective for a desired use of the filter membrane. Examples of useful thicknesses of a thin film porous membrane of the present description may be in a range from 10 to 300 microns, e.g., from 50 to 200 microns.

The membrane can have a porosity that will allow the membrane to be effective as described herein, to allow a suitable flow rate of liquid to pass through the membrane while also removing a high level of contaminants or impurities from the liquid. Examples of useful membranes can have a porosity of up to 80 percent, e.g., a porosity in a range from 60 to 80, e.g., 60 to 70 percent or from 40 to 60 percent. As used herein, and in the art of porous bodies, a “porosity” of a porous body (also sometimes referred to as “void fraction”) is a measure of the void (i.e. “empty”) space in the body as a percent of the total volume of the body, and is calculated as a fraction of the volume of voids of the body over the total volume of the body. A body that has zero percent porosity is completely solid.

The size of the pores (“pore size”) of a membrane (i.e., the average size of pores throughout the membrane) can be a size that in combination with the porosity and thickness of the membrane provides for desired flow of liquid fluid through the membrane while also performing a desired high level of a filtering (based on retention).

A pore size that will be useful for a particular membrane can depend on factors such as: the thickness of the membrane; the desired flow properties (e.g., flow rate or “flow time”) of fluid through the membrane; desired level of filtering (e.g., as measured by “retention”); the particular type of fluid that will be processed (filtered) by passing through the membrane; the particular contaminant that will be removed from the fluid passing through the membrane; as well as other factors. For certain presently understood examples, useful pore sizes may be in a range from about 10, 20, 30 or nanometers, or 0.05 microns, up to about 1, 3, 5, or 10 microns, e.g., of sizes sometimes classified as “microporous,” “ultraporous,” or “nanoporous”; for purposes of the present description and claims, the term “microporous” is sometimes used to refer to pores within any of these size ranges, including microporous and sub-microporous sizes, as a way of distinguishing from materials having larger pore sizes, i.e., to distinguish over materials that are considered to be “macroporous.”

Pore size of a membrane may also be assessed based on a correlation to the property known as “bubble point,” which is an understood property of a porous filter membrane. Bubble point corresponds to pore size, which may correspond to filtering performance, e.g., as measured by retention. A smaller pore size can correlate to a higher bubble point and often to higher filtering performance (higher retention). Normally, however, a higher bubble point also correlates to relatively higher resistance of flow through a porous material and a higher flow time (lower rate of flow for a given pressure drop).

Example filter membranes of the present description can exhibit a combination of a relatively high bubble point, good filtering performance, and a desirable level of flow, e.g., a flow rate that allows for the filter membrane to be used in a commercial filtering process. Example membrane can have a desirable combination of bubble point and flow time in comparison to comparable PEEK membranes made by different methods, including by methods that use a polar solvent. For example, a PEEK membrane made as described herein can have a combination of a relatively high bubble point and a relatively low flow time, with the combination of these properties being more desirable than a combination of bubble point and flow time of PEEK membranes produced using a different solvent.

By one method of determining the bubble point of a porous material, a sample of the porous material is immersed in and wetted with a liquid having a known surface tension, and a gas pressure is applied to one side of the sample. The gas pressure is gradually increased. The minimum pressure at which the gas flows through the sample is called a bubble point.

Examples of a porous filter membrane as described measured using a test method described herein can have an initial bubble point of at least 25, 30, or 40 pounds per square inch (psi) or greater, and mean bubble point of at least 25, 30, or 40 pounds per square inch (psi) or greater (measured using HFE-7200 (3M), at a temperature of 22 degrees Celsius). The membrane also exhibits useful properties of flow time and retention as described elsewhere herein.

In combination with a desired bubble point and filtering performance (e.g., measured by retention) a membrane as described can exhibit a useful resistance to flow of liquid through the membrane. A resistance to liquid flow can be measured in terms of flow rate or flow time (which is an inverse to flow rate). A membrane as described can preferably have a useful or a relatively low flow time, preferably in combination with a bubble point that is relatively high and good filtering performance. An example a PEEK membrane of the present description may have a measured flow time that is below about 10,000 seconds or under 5,000 seconds (measured using IPA as described infra), and a measured flow time that is below about 10,000 seconds, 5,000 seconds, or under 4,000 seconds (measured using water as described infra).

A level of effectiveness of a filter membrane to remove unwanted material (i.e., “contaminants”) from a liquid can be measured, in one fashion, as “retention.” Retention with reference to filtering performance of a filter membrane generally refers to a total amount of an impurity (actual or during a performance test) that is removed from a fluid that contains the impurity, relative to the total amount of the impurity that was in the fluid upon passing the fluid through the filter membrane. The “retention” value of a filter membrane is, thus, a percentage, with a filter having a higher retention value (a higher percentage) being relatively more effective in removing particles from a fluid, and a filter having a lower retention value (a lower percentage) being relatively less effective in removing particles from a fluid.

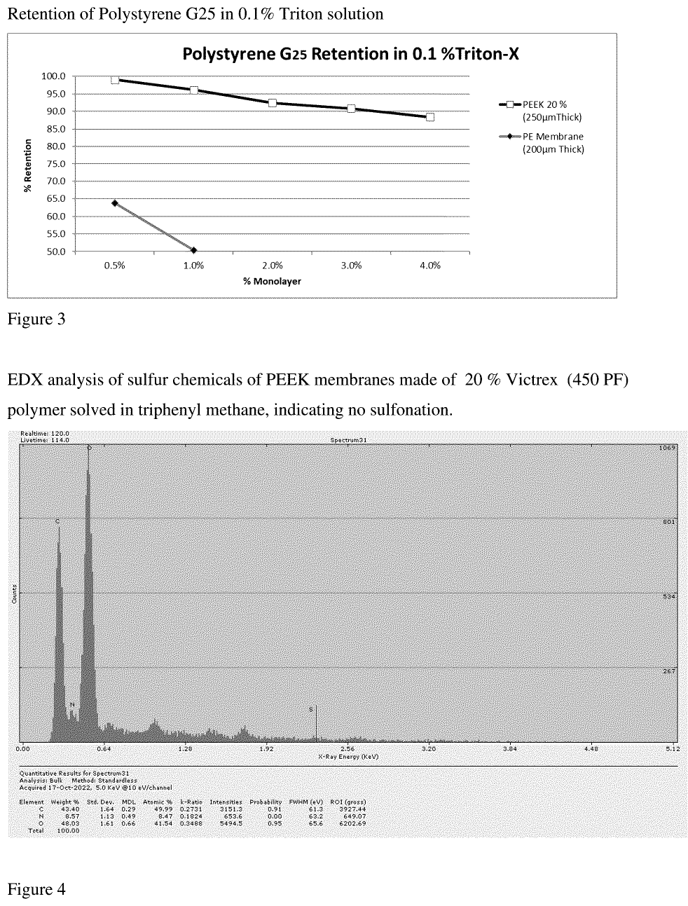

In example membranes prepared according the present description, a membrane can exhibit a retention that exceeds 80, 90, or 95 percent for a monolayer coverage of 1.0 percent, e.g., a retention that exceeds 80 of 85 percent for a monolayer coverage of 2.0, 3.0, or 4.0 percent, as measured using the test described in the Examples section, with a useful flow rate through the membrane. See FIG. 3.

A filter membrane as described can be useful to remove contaminants from a liquid by passing the liquid through the filter membrane to produce a filtered (or “purified”) liquid, referred to as a filtrate. The filtered liquid will contain a reduced level of contaminants compared to the level of contaminants present in the liquid before the liquid is passed through the filter membrane.

A filter membrane as described herein, or a filter or filter component that contains the filter membrane, can be useful in a method of filtering a liquid chemical material to purify or otherwise remove unwanted material from the liquid chemical material, especially to produce a highly pure liquid chemical material that is useful for an industrial process that requires a chemical material input that has a very high level of purity. Generally, the liquid chemical may be any of various useful commercial materials, and may be a liquid chemical that is useful in any of a variety of different industrial or commercial applications. Particular examples of filter membranes as described can be used for purifying a liquid chemical that is used or useful in a semiconductor or microelectronic fabrication application, e.g., for filtering a liquid solvent or other process solution used in a method of semiconductor photolithography (e.g., a liquid photoresist solution), a wet etching or cleaning step, a method of forming spin-on-glass (SOG), for a backside anti-reflective coating (BARC) method, etc.

Some specific, non-limiting, examples of liquid solvents that can be filtered using a filter membrane as described include: n-butyl acetate (nBA), isopropyl alcohol (IPA), 2-ethoxyethyl acetate (2EEA), a xylene, cyclohexanone, ethyl lactate, gamma-butyrolactone, hexamethyldisilazane, methyl-2-hydroxyisobutyrate, methyl isobutyl carbinol (MIBC), n-butyl acetate, methyl isobutyl ketone (MIBK), isoamyl acetate, tetraethyl ammonium hydroxide (TMAH), propylene glycol monoethyl ether, propylene glycol methyl ether (PGME), 2-heptanone, cyclohexanone, sulfuric acid solutions (e.g., diluted), and propylene glycol monomethyl ether acetate (PGMEA).

The membrane can be contained within a larger filter structure such as a filter housing or a filter cartridge that is used in a filtering system. The filtering system will place the membrane, e.g., as part of a filter or filter cartridge, in a flow path of a liquid chemical to cause at least a portion of the flow of the liquid chemical to pass through the membrane so that the membrane removes an amount of impurities or contaminants from the liquid chemical. The membrane may be housed between the inlet and the outlet in any state, e.g., may be pleated, wound, etc. The structure of a filter or filter cartridge may include one or more of various additional materials and structures that support the membrane within the filter to cause fluid to flow from a filter inlet, through the membrane, and thorough a filter outlet, thereby passing through the membrane when passing through the filter.

### EXAMPLES

These examples compare example polymeric porous PEEK membranes that are made using three different polar solvents, as described in U.S. Pat. No. 4,957,917 (the '917 patent), to a membrane prepared using the non-polar solvent triphenylmethane.

For comparison, structural observations of membranes are shown as SEM (Scanning Electron Microscopy) images and pore size using liquid-liquid porosimetry, bubble point, and membrane filtering performance is compared as IPA or water flux.

Three polar solvents were selected from U.S. Pat. No. 4,957,817, as shown at Table 1:

| Polar Solvent | Boiling Point [° C.] |
|---|---|
| Diphenylsulfone | 379 |
| Benzophenone | 305 |
| Dimethylpthalalate | 284 |

Porous PEEK membranes were prepared as follows, using each of the three polar solvents:

### Casting Solution Preparation:

Victrex 450 PF PEEK polymer was placed in a 20 ml Borosilicate glass vial.
The polar solvent was added to the vial to achieve desired polymer concentration of between 5 and 40 weight percent based on total weight polymer and solvent.
The vial was covered with a cap, but not closed.
The vial was placed in a preheated vial heater for 1 hour. The vial heater was heated close to the boiling point of the contained solvent, usually 10° C. below boiling point. The heating temperature for diphenyl sulfone was set to 320° C.
   Membrane Casting from the Casting Solution:
A smooth glass plate was placed on an Ecometer Film Applicator (Model: 4340) and heated to 195° C.
A casting knife with a set gap of 4 mils (Model: BKY) was heated to 300° C. and placed on the glass plate.
The casting solution was placed on the preheated glass plate and the membrane was cast at a casting knife speed of 30 millimeters per second. No other controls, such as environmental control, were used.
The film formed from the cast solution was removed from the glass plate and placed in acetonitrile for 15 minutes to remove the polar casting solution solvent.

### Results for Membranes Produced Using Diphenylsulfone

PEEK casting solutions were prepared using concentration of PEEK in a range of 20-50 weight percent PEEK in diphenyl sulfone (based on total weight PEEK and diphenyl sulfone). Membranes made with a concentration of 20 weight percent PEEK were fragile and subject to tearing. Membranes made with a concentration of PEEK above 20 weight percent seemed to be mechanically more stable and were selected for flux and SEM analysis.
SEM indicated that membranes prepared using diphenyl sulfone under same conditions as used for other solvents had a skinning effect (no pores) on both side of the surface, as seen in FIGS. 2 A and 2 B. Some membrane areas could show some flux, but where too fragile to be tested for bubble point. Most membranes prepared using diphenyl sulfone as a solvent showed matrix walls in the form of spherical structures, which were partially fused together (see FIGS. 2C, 2D). The non-fused areas between the particles formed the internal pore area of the membrane and thus the high internal pore size of diphenyl membrane (seen in table 2). This high pore size is not noticed for membranes produced with triphenyl methane.

### Results for Membranes Produced Using Benzophenone

Polymer concentrations in a range of from 20 to 30 weight percent PEEK in benzophenone (based on total weight PEEK and benzophenone) were explored. Membranes were cast and showed adequate mechanical strength. SEM indicated skinning areas (no pores) on one surface and open surface on the other side (Air side) for the sample made from 20 weight percent PEEK as seen in FIGS. 2 E and 2F. The difference between mean flow pore size and largest pore is approximately 5 times, suggesting that there are some areas on the closed membrane surface with big openings leading to an open cross section area, as seen in FIG. 2H. The air side is completely open, suggesting that these membranes are asymmetric in nature.
The sample with 25 weight percent PEEK showed similar properties. Some small pores, in this case defects were noticeable.
Heating the casting solution close to the boiling point leads to less control over the casting conditions.
   The increase in polymer concentration from 20 to 25 percent for PEEK membranes made with benzophenone changes the membrane morphology as seen in FIGS. 2L and 2H, where thick fibers are noticed and membrane appears to be less fibrillated at higher polymer concentration. When flowtime was measurable, it did increases for a 25% PEEK membrane approximately 20 times. In contrast, PEEK membranes made with triphenyl methane are highly fibrillated and uniform throughout the cross section as seen in FIG. 2T. Casting side of triphenylmethane PEEK membranes show regular porosity, as seen in FIG. 2R.

### Results for Membranes Produced Using Dimethyl Phthalate

A concentration of 5 weight percent PEEK in dimethyl phthalate (based on total weight PEEK and dimethyl phthalate) was selected as mentioned in the '917 patent. The boiling point of dimethyl phthalate is the lowest of all selected solvents being at 284° C., however the necessary melting point temperature for PEEK was observed to be at a minimum of 300° ° C. A single attempt was made to cast a membrane. The cast membrane was very small in size (enough for SEM analysis) and based on SEM analysis it was determined that this solvent is not useful to produce a meaningful membrane sample.
The prepared sample was not large enough to perform performance testing. The cross section of the sample prepared, indicated that the fibrillation is irregular with big pores in the cross section. See FIGS. 2M, 2N, 2O, and 2P. The air side is open and casting side indicates skinning (no pores), which is similar to PEEK membranes made using benzophenone or diphenyl sulfone as solvent. For comparison, membranes made using triphenyl methane show good surface porosity on both sides of the membranes and good fibrillation within the membranes.

### Comparison—Results for Membranes Produced Using Triphenylmethane

Membranes were prepared using casting solutions that contained from 20 to 30 weight percent PEEK in triphenylmethane (based on total weight PEEK and triphenylmethane). Membranes made with a concentration of 20 weight percent PEEK were mechanically stable and were selected for flux and SEM analysis.
SEM indicated no skinning on any surface; this is visible in SEM images, where pores are visible on both membrane surfaces. See FIGS. 2Q and 2R.
Porosity measurements through liquid-liquid porosimetry, gravimetric measurements support the SEM observations, where triphenylmethane creates unique membrane, which is highly porous, seen in Table 4.

### Membrane Performance Comparison—Overview

Table 2 below shows available membrane properties of PEEK membranes made of different polar solvents as selected and shown in Table 1. Membrane comparison of flow properties, bubble point and pore size data is shown. Data which was not obtainable due to mechanical instability of membrane or no processibility during casting is marked in Table 2 as NA (Not Available). Membranes prepared using diphenyl sulfone were not mechanically stable when polymer concentration was below 30 percent. Membranes obtained with 40 percent PEEK concentrations were stable enough to perform characterizations.

TABLE 2
Comparison of PEEK membranes prepared from various solvents to its membrane
performance. Membrane performance is shown as IPA/Water flux, Bubble point (BP) and pore size.

| | | | Flow Properties | | | | | | | | |
|---|---|---|---|---|---|---|---|---|---|---|---|
| Casting Solution | | | IPA | IPA | Water | Water | Bubble point | | Porometrie | | |
| | Polymer | | Flow | Flow | Flow | Flow | BP | Mean | Mean Flow | Largest | Smallest |
| Solvent | Concentration | Thickness | time | [LMH/ | time | [LMH/ | Initial | BP | Pore | Pore | Pore |
| Type | [%] | [μm] | [sec] | bar] | [sec] | bar] | [psi] | [psi] | size [nm] | [nm] | [nm] |
| Triphenyl | 20 | 130 | 3481 | 383 | 2263 | 589 | 47 | 57 | 180 | 497 | 81 |
| methane | | | | | | | | | | | |
| Diphenyl | 40 | 150 | 8899 | 412 | 7614 | 175 | NA | NA | 676 | 2104 | 257 |
| sulfone | | | | | | | | | | | |
| Benzophe | 20 | 100 | 1905 | 699 | 2731 | 488 | 14 | 23 | 158 | 810 | 73 |
| none | | | | | | | | | | | |
| Dimethyl | 5 | NA | NA | NA | NA | NA | NA | NA | NA | NA | NA |
| Phthalate | | | | | | | | | | | |

Table 3 shows best achievable membrane properties of Victrex 450 Pf PEEK membranes made at 20 and 23 percent PEEK using triphenyl methane as solvent.

TABLE 3
Best achieved data with PEEK 450 pf Triphenylmethane membrane at different polymer
concentrations.

| Casting Solution | | | Flow Properties | | Bubble point | | Porometrie | | |
|---|---|---|---|---|---|---|---|---|---|
| | Polymer | | IPA | IPA | BP | Mean | Mean | Largest | Smallest |
| Solvent | Concentration | Thickness | Flow | Flow | Initial | BP | Flow Pore | Pore | Pore |
| Type | [%] | [um] | time [sec] | [LMH/bar] | [psi] | [psi] | size [nm] | [nm] | [nm] |
| Triphenyl | 20 | 140 | 7324 | 180 | 43 | 110 | 47 | 96 | 20 |
| methane | | | | | | | | | |
| Triphenyl | 23 | 100 | 1300 | 101 | 62 | 102 | 29 | 58 | 23 |
| methane | | | | | | | | | |

Table 4 shows the porosity comparison between PEEK membranes produced using triphenylmethane, diphenyl sulfone, and benzophenone. As presented, membranes made using triphenylmethane exhibit a comparatively high porosity, which is comparable to the SEM observations in FIGS. 2Q-TF. Membranes prepared using diphenylsulfone showed a high pore area, which corresponds to the observation noticed in the SEM images, where round particles are noticed and loosely connected, resulting in an open membrane structure. This open structure is present even though PEEK-diphenylsulfone membranes were made at a higher concentration, due to its mechanical stability problems.

TABLE 4

| | Gravimetric | Porometer |
|---|---|---|
| | Analysis | Analysis |
| | Porosity | Total pore |
| Solvent Type | [%] | Area[um²] |
| Triphenylmethane | 78 | 12.93 |
| Benzophenone | 64 | 10.43 |
| Diphenyl sulfone | 66 | 22.77 |

Table 5 below shows different molecular weight PEEK types ranging from 70 k to >100 k from vendor Victrex.

TABLE 5
Comparison of different PEEK grades from Victrex. Polymers are compared by their
melt viscosity, molecular weight and percent crystallinity.

| | | Melt | | | | |
|---|---|---|---|---|---|---|
| | Type of | viscosity | | | Crystallite | |
| Vendor | PEEK | (Pa · s) at | Mw | Crystallinity | Size | |
| (Name) | (ID) | 400° C. | PEEK | (%) | (nm) | Note |
| Victrex | 150 PF | 130 | 72 K | 37 | 16.3 | High Flow grade |
| Victrex | 450 PF | 350 | 98 K | 30 | 14.6 | Standard Extrusion |
| | | | | | | grade |
| Victrex | 650 PF | 500 | >100 K | 25 | Unknown | High MV Grade |

Note
that the membrane prepared from Victrex 150 PF having a molecular weight of 72K was not mechanically stable.

### Bubble Point Test

To measure the mean bubble point, a sample flat sheet membrane is placed in a holder. Air is pressurized through the holder and the flow rate measured as a function of pressure. A low surface tension fluid, HFE-7200 (3M) is then introduced to the membrane to wet the membrane. Air is pressurized through the holder and the air flow is measured as a function of pressure. The mean bubble point is the pressure at which the ratio of the air flow of the wet membrane to the air flow of the dry membrane is 0.5. The test is performed at a temperature in a range of between 20 and 22 degrees Celsius.

### Coverage Test

“Particle retention” or “coverage” refers to the percentage of the number of particles that can be removed from a fluid stream by a membrane placed in the fluid pathway of the fluid stream. Particle retention of a sample filter membrane disc can be measured by passing a sufficient amount of an aqueous feed solution of 0.1% Triton X-100, containing 8 ppm polystyrene particles having a nominal diameter of 0.03 microns (available from Duke Scientific G25B), to achieve 1% monolayer coverage through a membrane at a constant flow of 7 mL/min, and collecting the permeate. The concentration of the polystyrene particles in the permeate can be calculated from the absorbance of the permeate. Particle retention is then calculated using the following equation:

$$particleretention = \frac{[ feed ] - [ filtrate ]}{[ feed ]} \times 100 \% .$$

The number (#) of particles necessary to achieve 1% monolayer coverage can be calculated from the following equation:

$$\# ofparticlesfor 1 \% monolayer = \frac{a}{\frac{\sqrt{3}}{2} {d}_{p}^{2}} \times \frac{1}{100}$$

where
a=effective membrane surface area
dₚ=diameter of the particle

“Nominal diameter,” as used herein, is the diameter of a particle as determined by photon correlation spectroscopy (PCS), laser diffraction or optical or SEM microscopy. Typically, the calculated diameter, or nominal diameter, is expressed as the diameter of a sphere that has the same projected area as the projected image of the particle. PCS, laser diffraction and optical microscopy techniques are well-known in the art. See, for example, Jillavenkatesa, A., et al.; “Particle Size Characterization;” NIST Recommended Practice Guide; National Institute of Standards and Technology Special Publication 960-1; January 2001.

### “Flow Time” Test (Using Isopropanol)

Isopropanol permeability (“flow”) can be determined using an internal flow test. The membrane is placed in a holder with the first side on the upstream. Isopropanol is fed through the sample at a specified pressure, i.e., 14.2 psi, for a predetermined interval at a temperature of 20 to 22 degrees C. Then, the isopropanol flowing through the membrane is collected and measured. Isopropanol permeability is calculated from the following equation:

$$P = \frac{V}{t \times a \times p}$$

where:
V=volume of isopropand collected
t=time of collection
a=effective membrane surface area
p=pressure drop across the membrane

Further, flow time is defined as the time it takes to collect 500 ml of fluid through a membrane with a surface area of 13.8 cm² at 14.2 psi. So a fixed volume of IPA (V) can be collected for a time (t) using a given membrane surface area (a) at 14.2 psi. The flow time (T) can be calculated using the following equation:

$$T = t * \frac{a}{13.8} * \frac{500}{V}$$

Membrane porosity can be determined through a gravimetric method. First, membrane is dried in oven at 120° C. for 5 min and its initial weight is determined. Next, membrane is placed in 100% IPA and immersed for 2 min. Excess of IPA is removed from surface and wet weight of membrane is determined. The resulting porosity can be calculated as follows:

$$ε = \frac{{Mass}_{wet} - {Mass}_{dry}}{ρ * {A}_{Membrane} * {L}_{Membrane}}$$

where:
Mass_{wet}=Mass of IPA wetted membrane
Mass_{dry}=Mass of dried membrane
p=Density of IPA
A_{Membrane}=Area of membrane
L_{Membrane}=Thickness of membrane

1. A porous polyether ether ketone membrane having:
a flow time of less than 10,000 seconds measured using isopropyl alcohol (500 milliliters) with a membrane surface area of 13.5 cm², and a pressure of 14.5 psia, and
an initial bubble point of at least 25 pounds per square inch (psig), measured using HFE-7200 at a temperature of 21 degrees Celsius.

2. The membrane of claim 1, having a porosity in a range from 70 to 85 percent.

3. The membrane of claim 1, having
a flow time of less than 4,000 seconds measured using isopropyl alcohol (500 milliliters) with a membrane surface area of 13.5 cm², and a pressure of 14.5 psia, and
an initial bubble point of at least 30 psig, measured using HFE-7200 at a temperature of 21 degrees Celsius.

4. The membrane of claim 1, having a mean bubble point of at least 40 psig, measured using HFE-7200 at a temperature of 21 degrees Celsius.

5. The membrane of claim 1, having a thickness in a range from 50 to 200 microns.

6. The membrane of claim 1, comprising a sheet.

7. The membrane of claim 1, wherein the polyether ether ketone is non-sulfonated.

8. The membrane of claim 1, wherein the polyether ether ketone has a molecular weight in a range from above 75 Mw and 125 Mw.

9. The membrane of claim 1, comprising residual solvent having a boiling point that is higher than a melting point of the polyether ether ketone.

10. The membrane of claim 9, wherein the residual solvent is triphenylmethane.

11. A filter product containing a membrane of claim 1.

12. A method of purifying a liquid, the method comprising passing the liquid through a membrane of claim 1.

13. A method of preparing a porous polyether ether ketone membrane, the method comprising:
preparing a combination comprising:
from 20 to 40 weight percent polymer that comprises polyether ether ketone, and
from 60 to 80 weight percent solvent that has a boiling point that is higher than a melting point of the polymer, based on total weight of the combination,
heating the combination to form a homogeneous casting solution,
causing polyetherether ketone of the casting solution to coagulate to form a porous membrane, and
removing solvent from the porous membrane.

14. The method of claim 13, wherein the solvent has a boiling point of at least 320 degrees Celsius.

15. The method of claim 13, wherein the solvent is triphenylmethane.

16. The method of claim 13, wherein the polyetherether ketone has a molecular weight in a range from above 75 Mw and 125 Mw.

17. The method of claim 13, wherein the membrane has a flow time of less than 10,000 seconds measured using isopropyl alcohol (500 milliliters) with a membrane surface area of 13.5 cm², and a pressure of 14.5 psia.

18. The method of claim 13 the membrane having a porosity in a range from 70 to 85 percent.

19. The method of claim 13, the membrane having an initial bubble point of at least 25 psig, measured using HFE-7200 at a temperature of 21 degrees Celsius.

20. The method of claim 13, the membrane having a mean bubble point of at least 40 psig, measured using HFE-7200 at a temperature of 21 degrees Celsius.

21. A homogeneous polymer-containing liquid comprising polyether ether ketone polymer melted in solvent, the liquid comprising:
from 20 to 40 weight percent polymer that comprises polyetherether ketone, and
from 60 to 80 weight percent solvent that has a boiling point that is higher than a melting point of the polyether ether ketone,
based on total weight polymer-containing liquid.

22. The liquid of claim 21, wherein the solvent has a boiling point of at least 320 degrees Celsius.

23. The liquid of claim 21, wherein the solvent is triphenylmethane.

24. The liquid of claim 21, the polymer comprising at least 90 weight percent polyetherether ketone based on total weight polymer.

25. The liquid of claim 21, wherein the polyetherether ketone has a molecular weight in a range from 75 Mw to 125 Mw.

26. The liquid of claim 21, consisting essentially of the polymer and the solvent.
